(19) United States
(12) Patent Application Publication
(10) Pub. No.: US 2016/0364850 A1
(43) Pub. Date: Dec. 15, 2016

(54) Life Force Index Calibration Methodology

(71) Applicants: Paul L. Evans, Atlanta, GA (US); Aimon T. Kopera, Atlanta, GA (US)

(72) Inventors: Paul L. Evans, Atlanta, GA (US); Aimon T. Kopera, Atlanta, GA (US)

(21) Appl. No.: 14/736,311

(22) Filed: Jun. 11, 2015

(51) Int. Cl. G06T 7/00; G09B 19/00

(52) U.S. Cl. CPC G06T 7/0004; G09B 19/0092; G06T 2207/30128

(57) ABSTRACT

This invention comprises a calibration methodology determined from the optical image area displayed by photons emitted by solid or liquid food. The method comprises calculating the square root of the mean area density image value which produces a “Life Force Index”, a novel indices for dietary planning, that can be used in conjunction with (or independently of) conventional caloric indices and nutrition indices of solid and fluid foods to help consumers of food products select biologically robust products and manufacturers of food products more precisely represent the bio-vitality of the products.

### CROSS-REFERENCE TO RELATED APPLICATIONS

This application claims the benefit of U.S. Provisional Application Ser. No. 62/027,920, filed Jul. 23, 2014, the contents are incorporated herein by reference.

### STATEMENT REGARDING FEDERALLY SPONSORED RESEARCH AND DEVELOPMENT

(Not Applicable)

### REFERENCE TO SEQUENCE LISTING, A TABLE OR A COMPUTER PROGRAM LISTING COMPACT DISC

(Not Applicable)

### BACKGROUND OF THE INVENTION

Accurately confirming the quality of solid and fluid food is important to both producers and consumers. Although various methods have been developed, inconsistencies in methodology for caloric and nutritional assessment and labeling can be significant and misleading to consumers. The present invention overcomes these drawbacks.

The original method used to determine the number of calories in a given food directly inferred the energy it produced. The food was placed in a sealed container surrounded by water—an apparatus known as a bomb calorimeter. The assumption behind the science of calorimetry is that the energy gained or lost by the water is equal to the energy lost or gained by the specimen under study. The food was completely burned and the resulting rise in water temperature was measured and the calorie or energy of the food was calculated.

Today, calories may be calculated using any one of several methods. However, these methods, including improved bomb calorimeters, are at best, limited as models of potential energy for the human body. Ideally, calories should represent physiological energy, not the energy loss based on an experimental method of energy displacement.

A problem in the related art of assessment of nutrient values of food also exists. Nutrient analysis is essentially a biochemical process. Yet methods are inconsistent. Manufacturers of processed foods have several choices. They can take samples from different batches and have them analyzed for their chemical components. There are one or more methods of analysis for each constituent. If manufacturers choose to report them individually, carbohydrate constituents like sugars, starches, dietary fiber, sugar alcohols, etc. must be determined by chemical analysis. But the value reported on the “Total Carbohydrate” is often calculated by difference, not by adding up the individual components. This leads to difficulties, because it is possible to have a food label where the weight of any or all of the carbohydrate constituents reported somewhat exceeds the weight listed for total carbohydrates and that can confuse consumers.

The present methodology calibrates a biophysical process, not a biochemical one, through the examination of optical imagery produced by the energetic interactions and reciprocities of living matter.

Biophysics presents a model of energy potential of solid and fluid foods for the human body because biophysics defines life as energy. From a biophysics perspective when the energy content of a specimen is examined the analysis is done at the atomic and subatomic level. The atoms of a specimen are surrounded by electrons composed of quantum light energy called photons. Every form of matter is characterized by a specific frequency of light energy, i.e., photons. These photons are identifiers of energy in solid food and liquid consumables and they can reveal its biophysical value which is geometrically structured at the atomic level to convey energy.

The calibration method of this invention is based on the measurement of the optical image area displayed by photons emitted by solid or liquid food upon electrical excitement. It comprises a method for calibration and quantifying an image of a specimen of material or liquid by measuring the area coverage (the area of electro photonic emission, which we define as “life force”) of photons emitted by the material which has been subject to short electrical pulses and calibrating the resultant photon emission image area and assigning a numerical “Life Force Index” based on the calibration.

### BRIEF SUMMARY OF THE INVENTION

The present invention is a material and liquid assay standardization methodology which calibrates food and fluid not on displaced heat or biochemical analysis but on the biophysical image capture and measurement of the root mean square of area intensities of photon emissions from solid or fluid food.

Images are captured from commercially produced charged coupled device (CCD) digital cameras and software. The cameras offer high frame rates and quality noise reduction with small pixel output providing extremely high resolution. These devices have digital output that ensures compatibility with a large number of commercially available frame grabbers allowing short “films” of the photon discharge to be recorded on attached computers as audio video interleaved (avi) files. The avi files are then converted to a series of Bitmap (BMP) files, and the area (the number of light-struck pixels) and average intensity parameters are generated by commercially available computer software for every image. The advantages of developing a calibration system based around commercial image analysis packages are their wide scale availability for research and codification of the present invention in commercial use.

### BRIEF DESCRIPTION OF THE DRAWINGS

The particular aspects of the invention will now be explained with reference to the embodiments described hereinafter and considered in connection with the accompanying drawings. The CCD camera and image capture process is presented in FIGS. 1-3 of the drawings, in which:

FIG. 1 illustrates preparing and placing a specimen into the sample chamber;

FIG. 2 illustrates exciting the specimen by voltage pulses for implementing the measurement;

FIG. 3 illustrates detecting the area of the photons emitted by the sample after being excited.

The time series images that are taken in 0.2 second intervals for each specimen over a 10 second period is presented in FIG. 4 and FIG. 5 of the drawings, in which:

FIG. 4 illustrates the graph of the calibration methodology for the calculation according to the embodiments of the invention; and,

FIG. 5 illustrates the mathematical formula for deriving the Life Force Index.

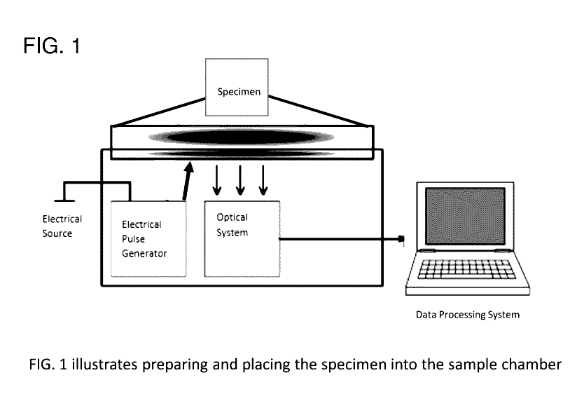

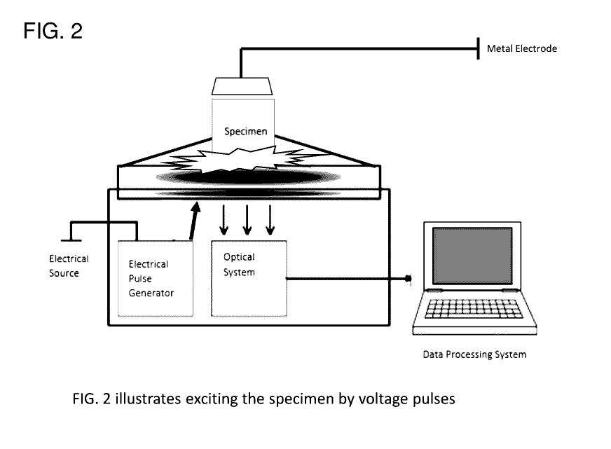

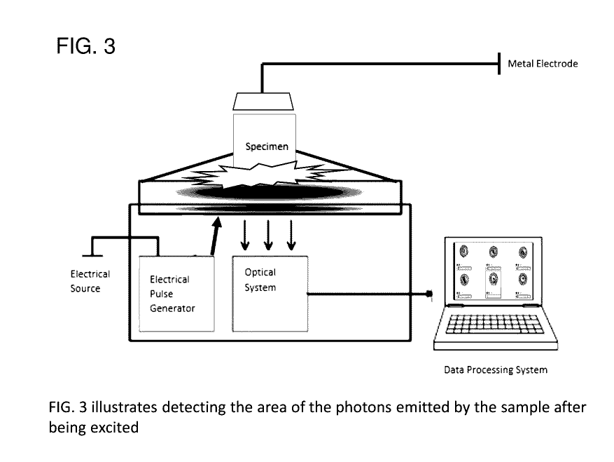

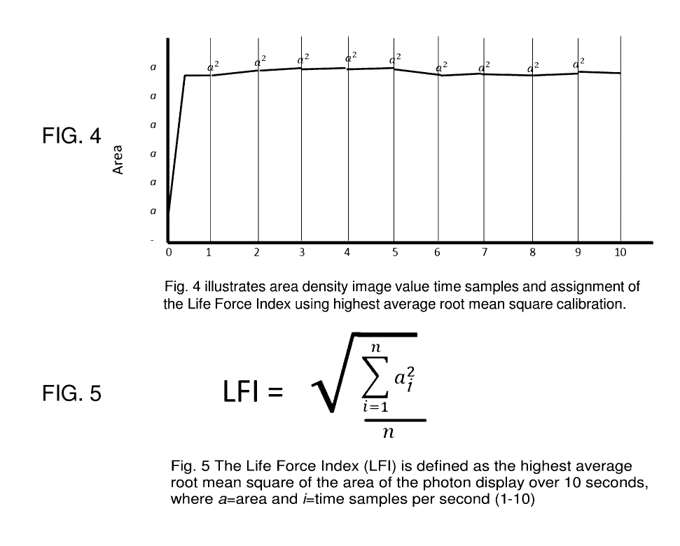

These calibrated images result in an energy value, the “Life Force Index”, which more directly states the bio-value and energetic properties of the product to be consumed. By capturing and indexing the level of photon emissions the methodology provides an alternative and/or compliment to current methods for classification and rating of caloric and nutrient indices of solid and fluid food.

### DETAILED DESCRIPTION OF THE INVENTION

All biological objects emit photons including animal tissue, plants and fluids. In biology these photons participate in the processes of physiological regulation and bio-oxidation. Thus, from a biophysics point of view, organic compounds serve as the working material for the conversion of light energy. The data obtained when measuring ‘bio-photons’ is invaluable scientific information, highlighting the role of electro-photonic processes in the functioning of biological matter.

The present invention is comprised of a methodology for the calculation and assignment of a “Life Force Index”. The methodology calculates the area of photons emanating from biological objects which results in the quantification of a Life Force Index by assigning values that represent the area of photon emission from the specimen of solid material or fluid under analysis.

The Life Force Index calibration methodology is based on the stimulation of photon emissions from the specimen. When stimulated by short electrical pulses specimens emit light directly producing photons instead of heat.

The devices used for capturing images of photon emission are commercially produced charged coupled device digital cameras (e.g., UV CCD digital cameras, and Gaseous Discharge Visualization cameras or Electro Photonic Imaging cameras). The principle of image formation is as follows:

In the apparatus solid or liquid material (the specimen) is placed on a transparent electrode glass plate. A common grounding electrode is connected to the top surface of the specimen and plugged into the apparatus via a grounding cord.

Next voltage impulses are directed to the specimen via a transparent current conductive coating layer on the glass plate in the apparatus. Upon stimulation, a high photonic field is created in the contact space of the specimen and electrode glass resulting in photonic discharge from the specimen whose characteristics are determined by the specimen's bio-physical properties. An optical camera system captures the discharge photon area as a series of photographic images that are taken and the area (the number of light-struck pixels) average intensity (ranked from zero for absolute black to 255 for absolute white) parameters are generated by the software for every image. The time series images are taken over 0.2 second intervals for each specimen for a duration of 10 seconds.

The Life Force Index is defined as the highest average root mean square of the area of the photon display over 10 seconds. The calibration considers variation in the individual pixels within each area and is estimated statistically from the standard deviation of the number of detected photons. The standard deviation is calculated from the square root of the mean assuming the photon number follows a Poisson distribution and variation arises by what is called Quantum Noise. Specifically, the Life Force Index is found by calculating the square root of the mean area density image value.

Having described our process, we claim:

1. A calibration method for examining the biophysical property of a specimen (solid or liquid food) by measuring the area of photon emission emitted by specimens excited by low voltage pulses as indicated by images of photon emission produced by charged coupled device digital cameras resulting in a novel indices, The Life Force Index, for dietary planning.

2. A calibration method according to claim 1, wherein a specimen is positioned in a charged coupled device digital camera apparatus for examination and excited by low voltage pulses and the resultant discharge photon area is displayed as a series of photographic images that are taken and calibrated over 0.2 second intervals for each specimen for 10 seconds duration.

3. A calibration method according to any of claims 1 to 2, wherein the photon emission area is calibrated and assigned a “Life Force Index” value according to the highest average and root mean square of the area of the photon display over 10 seconds duration.

4. A method for calibrating the “Life Force Index” as claimed in 1 to 3, said method comprising a means for examination of photon density images emitted by a specimen and measuring the areas of the photon density and arriving at a Life Force Index.

5. The use of the calibration method according to claims 1 to 4, for examining the photonic properties of a specimen of material and assigning a value for a Life Force Index.

6. A calibration method as claimed in 1 to 5 used as a means to detect and establish a Life Force Index of solid and fluid food specimens by examination of the area density of photon images emitted after excitation with low voltage pulses.

7. A Life Force Index as claimed in 1 to 6 that can be calibrated from the area of photon density and assigned to food products and used to help consumers of food products select biologically robust foods and manufacturers of food products to more accurately represent the bio-vitality of the products.
